(19) United States
(12) Patent Application Publication
(10) Pub. No.: US 2024/0392854 A1
(43) Pub. Date: Nov. 28, 2024

(54) METAL FOIL FOR SPRING MEMBER, PRODUCTION METHOD FOR METAL FOIL FOR SPRING MEMBER, AND SPRING MEMBER FOR ELECTRONIC DEVICE

(71) Applicant: TOPPAN HOLDINGS INC., Tokyo (JP)

(72) Inventors: Shinichi SHIMAMURA, Tokyo (JP); Akihiko Kobayashi, Tokyo (JP); Hiroyasu Aizawa, Tokyo (JP)

(21) Appl. No.: 18/796,068

(22) Filed: Aug. 6, 2024

Related U.S. Application Data
(63) Continuation of application No. PCT/JP2023/004600, filed on Feb. 10, 2023.

(30) Foreign Application Priority Data
Feb. 10, 2022 (JP) 2022-019988
Sep. 20, 2022 (WO) PCT/JP2022/035025
Sep. 30, 2022 (JP) 2022-158953

(51) Int. Cl. F16F 3/02; B21B 3/00; C22F 1/00

(52) U.S. Cl. CPC F16F 3/023; B21B 3/00; C22F 1/00; F16F 2224/0208; F16F 2226/04; F16F 2228/001

(57) ABSTRACT

A metal foil for a spring member includes a first region on which the spring member is formed. The first region has a square shape with one side being 300 mm. In the first region, an absolute value of a difference value obtained by subtracting variance of a thickness in a width direction orthogonal to a rolling direction from variance of a thickness in the rolling direction is less than or equal to 0.15 μm². In the first region absolute value obtained by subtracting a second maximum value from a first maximum value is less than or equal to 0.8 μm².

### BACKGROUND

The present disclosure relates to a metal foil for a spring member, a method for manufacturing a metal foil for a spring member, and a spring member for an electronic device.

A camera module included in an electronic device with a camera, such as a tablet terminal or a smartphone, includes a drive mechanism for enabling autofocus and zoom. There are two known types of drive mechanisms: a lens drive method and a sensor drive method. The drive mechanism of the lens drive method includes a leaf spring that enables the position of the lens in an optical axis direction to be changed. The drive mechanism of the sensor drive method includes a leaf spring that enables the position of the lens of the image sensor in the optical axis direction to be changed (refer to, for example, Japanese Laid-Open Patent Publication No. 2014-059345 and Japanese Laid-Open Patent Publication No. 2020-170170).

The leaf spring needs to satisfy specific requirements for spring load and deflection within a limited volume. To satisfy the requirements for spring load and deflection, the leaf spring must be made of a high-hardness metal.

The width and thickness of the leaf spring contribute significantly to the spring load and deflection. A metal foil, which is the raw material for the leaf spring, is thinned to a predetermined thickness through rolling. Since the metal foil is made of a high-hardness metal, it is more difficult to achieve a uniform thickness of the metal foil through rolling compared to when it is made of a low-hardness metal.

The leaf spring is formed by wet-etching a metal foil. Variations in the thickness of the metal foil cause variations in the amount of etching, which in turn causes variations in the width of the leaf spring in the thickness direction. Variations in the width of the leaf spring in the thickness direction cause variations in the spring load and deflection of the leaf spring. This necessitates minimizing the variations in the spring width in the thickness direction.

### SUMMARY

A metal foil for a spring member according to an aspect includes a first region on which the spring member is formed. The first region has a square shape with one side being 300 mm. In the first region, an absolute value of a difference value obtained by subtracting variance of a thickness in a width direction orthogonal to a rolling direction from variance of a thickness in the rolling direction is less than or equal to 0.15 μm². A maximum value of the thickness in the rolling direction is a first maximum value, a maximum value of the thickness in the width direction is a second maximum value. An absolute value obtained by subtracting the second maximum value from the first maximum value is less than or equal to 0.8 μm.

A method for manufacturing a metal foil for a spring member according to an aspect includes rolling a base material and preparing rolled materials obtained by rolling the base material and then selecting the metal foil for the spring member from the rolled materials. Each of the rolled materials includes a first region on which the spring member is formed. The first region has a square shape with one side being 300 mm. In the first region, a maximum value of a thickness in a rolling direction is a first maximum value, and a maximum value of a thickness in a width direction is a second maximum value. The selecting the metal foil for the spring member selects, from the rolled materials, as the metal foil for the spring member, the rolled material in which an absolute value of a difference value obtained by subtracting variance of the thickness in the width direction from variance of the thickness in the rolling direction is less than or equal to 0.15 μm² and an absolute value obtained by subtracting the second maximum value from the first maximum value is less than or equal to 0.8 μm.

A spring member for an electronic device according to an aspect includes is a spring member for an electronic device formed from a metal foil for a spring member. An absolute value of a difference value obtained by subtracting variance of a thickness of the metal foil for the spring member in a width direction orthogonal to a rolling direction from variance of the thickness of the metal foil for the spring member in the rolling direction is less than or equal to 0.15 μm². In the metal foil for the spring member, a maximum value of the thickness in the rolling direction is a first maximum value, a maximum value of the thickness in the width direction is a second maximum value, and an absolute value obtained by subtracting the second maximum value from the first maximum value is less than or equal to 0.8 μm.

### BRIEF DESCRIPTION OF DRAWINGS

FIG. 1 is a perspective view showing the structure of a metal foil for a spring member according to an embodiment.

FIG. 2 is a plan view showing the structure of a spring member for an electronic device according to the embodiment.

FIG. 3 is a diagram illustrating a step of the method for manufacturing the metal foil for the spring member in the embodiment.

FIG. 4 is a diagram illustrating a step of the method for manufacturing the metal foil for the spring member in the embodiment.

FIG. 5 is a diagram illustrating a step of the method for manufacturing the metal foil for the spring member in the embodiment.

FIG. 6 is a diagram illustrating a step of the method for manufacturing the spring member for the electronic device shown in FIG. 2.

FIG. 7 is a diagram illustrating a step of the method for manufacturing the spring member for the electronic device shown in FIG. 2.

FIG. 8 is a diagram illustrating a step of the method for manufacturing the spring member for the electronic device shown in FIG. 2.

FIG. 9 is a diagram illustrating a step of the method for manufacturing the spring member for the electronic device shown in FIG. 2.

FIG. 10 is a diagram illustrating a step of the method for manufacturing the spring member for the electronic device shown in FIG. 2.

FIG. 11 is a plan view illustrating the points where the thickness for the metal foil for the spring member is measured.

FIG. 12 is a table showing the measurement results of the metal foils of Examples and Comparative Examples.

FIG. 13 is a graph showing the relationship between the first absolute value and the difference value of the spring width.

FIG. 14 is a graph showing the relationship between the fourth absolute value and the difference value of the spring width.

FIG. 15 is a graph showing the relationship between the second absolute value and the difference value of the spring width.

FIG. 16 is a graph showing the relationship between the third absolute value and the difference value of the spring width.

### DESCRIPTION OF EXEMPLARY EMBODIMENTS

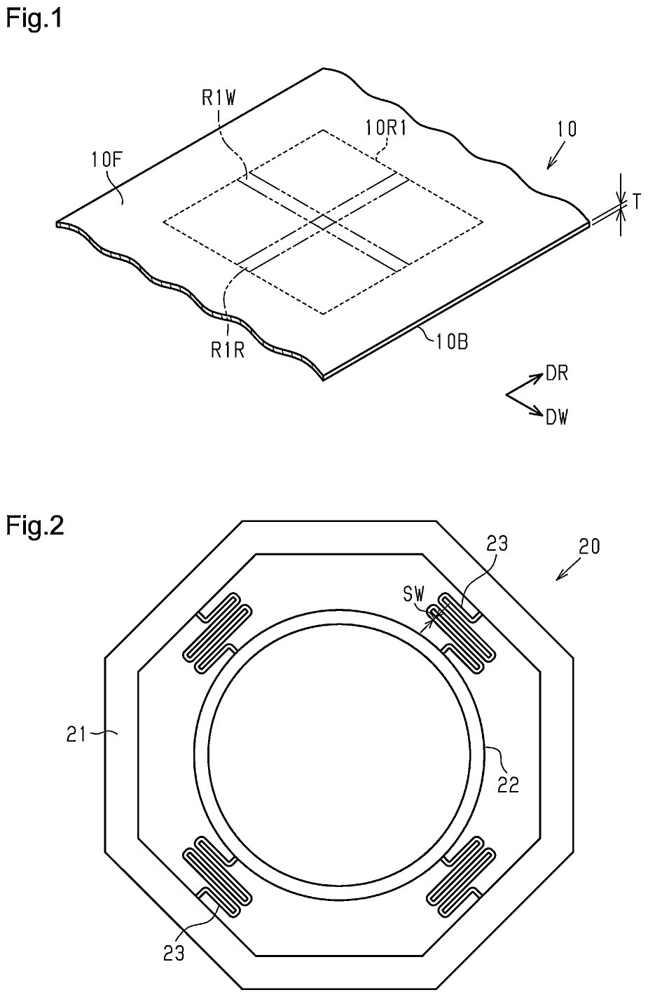

A metal foil for a spring member, a method for manufacturing a metal foil for a spring member, and a spring member for an electronic device according to an embodiment will now be described with reference to FIGS. 1 to 16.

### Metal Foil for Spring Member

The metal foil for the spring member will now be described with reference to FIG. 1.

In a metal foil 10 for a spring member (hereinafter also referred to as a metal foil 10) shown in FIG. 1, a region on which the spring member is formed is a first region 10R1. The first region 10R1 has a square shape with one side being 300 mm. The metal foil 10 is a rolled material made of metal having a hardness high enough to achieve a spring load or deflection required for the spring member. The metal foil 10 has a band shape extending in a rolling direction DR. The direction that is orthogonal to the rolling direction DR is a width direction DW. Thickness T of the metal foil 10 is, for example, less than or equal to 150 μm, and preferably between 50 μm and 120 μm, inclusive. The thickness of the metal foil 10 has such uniformity that the ratio of the difference value between the maximum value of thickness T of the metal foil 10 and the minimum value of the thickness to the average value of the thickness of a base material is less than or equal to 3%.

The metal foil 10 satisfies the following condition 1.

(Condition 1) In the first region 10R1, the absolute value of the difference value obtained by subtracting a first variance from a second variance is less than or equal to 0.15 μm² and the absolute value of the difference value obtained by subtracting a second maximum value from a first maximum value is less than or equal to 0.8 μm.

The standard deviation of the thickness in the rolling direction DR is the first variance. The variance of the thickness in the width direction DW is the second variance. The absolute value of the difference value obtained by subtracting the second variance from the first variance is a second absolute value. The first variance is the variance of the thickness at each point on a straight line extending in the rolling direction DR. The second variance is the variance of the thickness at each point on a straight line extending in the width direction DW.

The first maximum value is the maximum value of the thickness in the rolling direction DR. The second maximum value is the maximum value of the thickness in the width direction DW. The absolute value of the difference value obtained by subtracting the second maximum value from the first maximum value is a fourth absolute value.

Since the second absolute value is less than or equal to 0.15 μm² and the fourth absolute value is less than or equal to 0.8 μm, variations in the thickness of the metal foil 10 are limited. Thus, variations in the spring width in the thickness direction are limited in the spring member that has been formed by wet-etching the metal foil 10.

The metal foil 10 has a front surface 10F and a back surface 10B that is opposite to the front surface 10F. Thickness T of the metal foil 10 is the distance between the front surface 10F and the back surface 10B. The maximum value and the minimum value of the thickness in the rolling direction DR are specified as follows. A first measurement region R1R, having a band shape extending in the rolling direction DR, is set within the first region 10R1. The dimension of the first measurement region R1R in the width direction DW is, for example, 20 mm. Of the thicknesses of the metal foil 10 measured at multiple points on the straight line included in the first measurement region R1R, the largest value is the maximum value, and the smallest value is the minimum value.

The maximum value and the minimum value of the thickness in the width direction DW are specified as follows. A second measurement region R1W, having a band shape extending in the width direction DW, is set within the first region 10R1. The dimension of the second measurement region R1W in the rolling direction DR is, for example, 20 mm. Of the thicknesses of the metal foil 10 measured at multiple points on the straight line included in the second measurement region R1W, the largest value is the maximum value, and the smallest value is the minimum value.

The variations in thickness of the metal foil 10 in the rolling direction DR decrease as rolling is repeatedly applied to the material used to manufacture the metal foil 10. Thus, to limit variations in the rolling direction DR, increasing the number of rolling passes during the manufacturing of the metal foil 10 is preferred. However, the metal foil 10 for the spring member needs to have a thickness that is greater than or equal to a predetermined thickness to achieve the spring load or deflection required for the spring member. This hinders performing a sufficient number of rolling passes to completely eliminate the variations in thickness of the metal foil 10 for the spring member in the rolling direction DR during the manufacturing of the metal foil 10. In contrast, the variations in thickness of the metal foil 10 in the width direction DW are controlled by the surface condition of the roller used in the rolling. Accordingly, the variations tend to be limited regardless of the number of rolling passes. As a result, the second variance of the metal foil 10 tends to be less than or equal to the first variance.

When wet-etching is performed on the metal foil 10 to form through-holes that extend through the metal foil 10 in the thickness direction of the metal foil 10, the thinner the part of the metal foil 10, the shorter the time required to form the through-holes. The through-holes formed in the metal foil 10 create a flow of etchant between the front surface 10F and the back surface 10B of the metal foil 10. However, these through-holes do not significantly contribute to the isotropic etching of the metal foil 10 in the direction perpendicular to the through-holes. In contrast, the thicker the part of the metal foil 10, the longer the time required to form the through-holes. Accordingly, the thicker parts of the metal foil 10 significantly contribute to the progress of isotropic etching of the metal foil 10.

Thus, in the thickness of the metal foil 10, the first variance can be used as an index of the ease of isotropic etching in the rolling direction DR. Further, in the thickness of the metal foil 10, the second variance can be used as an index of the ease of isotropic etching in the width direction DW. Furthermore, the first absolute value can be used as an index of the ease of isotropic etching in the rolling direction DR relative to the width direction DW, in which isotropic etching is less likely to occur.

In this regard, when the metal foil 10 meets the aforementioned condition 1, it prevents the ease of isotropic etching in the rolling direction DR from being significantly greater than the ease of isotropic etching in the width direction DW. Thus, the desired shape is more likely to be obtained in the spring member formed by etching the metal foil 10.

In the first region 10R1, the standard deviation of thickness T in the rolling direction DR is a first standard deviation. That is, the first standard deviation is the standard deviation of thickness T at each point on one straight line in the rolling direction DR. In the first region 10R1, the standard deviation of thickness T in the width direction DW is a second standard deviation. That is, the second standard deviation is the standard deviation of thickness T at each point on one straight line in the width direction DW.

In the first region 10R1, the difference value between the maximum value and the minimum value of thickness T in the rolling direction DR is a first difference value. That is, thickness T at each point on one straight line in the rolling direction DR is a first thickness, and the difference value between the maximum value and the minimum value of the first thickness is the first difference value. In the first region 10R1, the difference value between the maximum value and the minimum value of thickness T in the width direction DW is a second difference value. That is, thickness T at each point on one straight line in the width direction DW is a second thickness, and the difference value between the maximum value and the minimum value of the second thickness is the second difference value.

The metal foil 10 preferably satisfies at least one of the following conditions 2 to 4. That is, the metal foil 10 may satisfy only one of the conditions 2 to 4, or may satisfy two or more selected from the conditions 2 to 4.

(Condition 2) The difference value obtained by subtracting the second standard deviation from the first standard deviation is less than or equal to 0.15 μm.

The difference value obtained by subtracting the second standard deviation from the first standard deviation is a third difference value.

(Condition 3) The difference value obtained by subtracting the second variance from the first variance is less than or equal to 0.15 μm².

The difference value obtained by subtracting the second variance from the first variance is a fourth difference value.

(Condition 4) The absolute value of the difference value obtained by subtracting the second difference value from the first difference value is less than or equal to 0.8 μm.

The absolute value of the difference value obtained by subtracting the second difference value from the first difference value is a third absolute value.

When the metal foil 10 meets conditions 2 to 4, similar to when the metal foil 10 meets condition 1, it prevents the ease of isotropic etching in the rolling direction DR from being significantly greater than the ease of isotropic etching in the width direction DW. Thus, the desired shape is more likely to be obtained in the spring member formed by etching the metal foil 10.

As described above, the metal foil 10 is a rolled material made of metal having a hardness high enough to achieve a spring load or deflection required for the spring member manufactured using the metal foil 10. The metal foil 10 may be made of, for example, a stainless alloy or a copper alloy. The stainless alloy may be, for example, stainless alloy specified in JIS G 4313:2011, “Stainless steel strip for springs.” The copper alloy may be, for example, copper alloy specified in JIS H 3130:2018, “Copper beryllium alloy, copper titanium alloy, phosphor bronze, copper-nickel-tin alloy and nickel silver sheets, plates and strips for springs.”

The metal foil 10 preferably includes any one selected from the group consisting of stainless alloy, beryllium copper, nickel-tin-copper, phosphor bronze, Corson alloy, and titanium copper. As a result, since the metal foil 10 can have a relatively high hardness, the durability of the spring member formed from the metal foil 10 is enhanced.

### Spring Member

The spring member will now be described with reference to FIG. 2. FIG. 2 schematically shows the planar structure of the spring member as viewed from a perspective facing the plane in which the spring member expands.

As shown in FIG. 2, the spring member 20 includes an outer frame 21, an inner frame 22, and spring portions 23. The spring member 20 is a leaf spring. In the example shown in FIG. 2, the outer shape of the outer frame 21 is octagonal, and the outer shape of the inner frame 22 is circular. Each spring portion 23 has a folded line shape. The outer shape of the outer frame 21 and the outer shape of the inner frame 22 may be changed depending on the shapes of other members included in the drive mechanism of the camera module on which the spring member 20 is mounted; that is, the members other than the spring member 20. The inner frame 22 is located in a region defined by the outer frame 21. The spring portions 23 connect the inner frame 22 to the outer frame 21.

In the drive mechanism of the lens drive method, two spring members 20 are arranged on opposite sides of the lens in the optical axis direction of the lens. A change in the position of the inner frame 22 connected to each outer frame 21, in relation to the outer frame 21, in the optical axis direction changes the position of the lens in the optical axis direction. This allows the lens drive mechanism to correct for camera shake.

In the drive mechanism of the sensor drive method, two spring members 20 are arranged on opposite sides of an imaging sensor in the optical axis direction of the lens. A change in the position of the inner frame 22 connected to each outer frame 21, in relation to the outer frame 21, in the optical axis direction changes the position of the imaging sensor in the optical axis direction. This allows the sensor drive mechanism to correct for camera shake.

In the spring member 20, in a plan view facing the plane in which the spring member 20 expands, the length in a direction orthogonal to the direction in which each side of the outer frame 21 extends is the width of the spring member 20 in the outer frame 21. Further, in a plan view facing the plane in which the spring member 20 expands, the length of the inner frame 22 in the radial direction of the inner frame 22 is the width of the spring member 20 in the inner frame 22. In addition, in a plan view facing a plane in which the spring member 20 expands, the line width of the folding line in the spring portion 23 in the plan view is the width of the spring portion 23; that is, a spring width SW.

The electronic device on which the camera module with the spring member 20 is mounted may be, for example, a mobile phone terminal, a smartphone, a tablet terminal, or a notebook personal computer.

### Method for Manufacturing Metal Foil for Spring Member

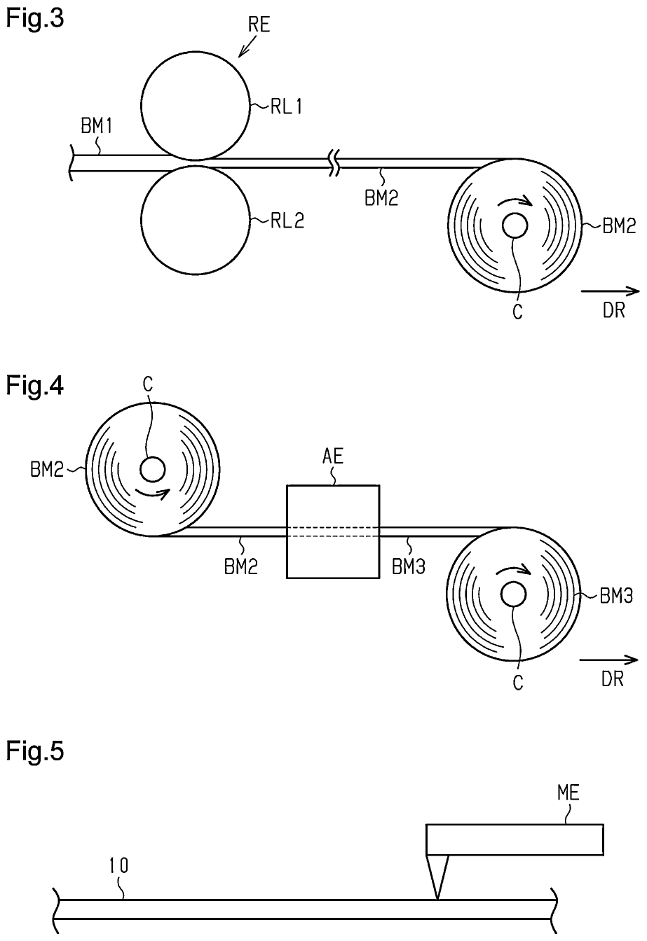

The method for manufacturing the metal foil 10 will now be described with reference to FIGS. 3 to 5.

The method for manufacturing the metal foil 10 includes rolling a base material, preparing rolled materials that have been obtained by rolling the base material, and then selecting the metal foil 10 from the rolled materials. In the selection of the metal foil 10, a rolled material satisfying the above-described condition 1 is selected from the rolled materials as the metal foil 10. The method for manufacturing the metal foil 10 may further include at least one of the above-described conditions 2 to 4 as a condition for selecting the metal foil 10 from the rolled materials. That is, the conditions for selecting the metal foil 10 may include only one of conditions 2 to 4, or may include two or more selected from conditions 2 to 4.

The method for manufacturing the metal foil 10 will now be described in more detail with reference to the drawings.

FIG. 3 schematically shows a step of rolling a base material that is used to form the metal foil 10. FIG. 4 schematically shows a step of annealing the rolled material.

As shown in FIG. 3, when the metal foil 10 is manufactured, first, a base material BM1, having a band shape extending in the rolling direction DR, is prepared. Next, for the rolling direction DR of the base material BM1 to become parallel to a conveying direction in which the base material BM1 is conveyed, the base material BM1 is conveyed in the conveying direction toward a rolling machine RE that includes two rollers RL1, RL2.

When the base material BM1 reaches the section between the two rollers RL1, RL2, the base material BM1 is rolled by the two rollers RL1, RL2. Thus, the thickness of the base material BM1 is reduced and the base material BM1 is extended in the conveying direction. As a result, the rolled material BM2 is obtained. The rolled material BM2 is wound around core C. The rolled material BM2 may be treated while it is extended in a strip shape without being wound around core C. The thickness of the rolled material BM2 is, for example, less than or equal to 150 μm, and preferably between 50 μm and 120 μm, inclusive.

As shown in FIG. 4, in order to remove the residual stress accumulated inside the rolled material BM2 that has been formed by the rolling of the base material BM1, the rolled material BM2 is annealed using an annealing apparatus AE. Thus, the annealed rolled material BM3 is obtained. Since the rolled material BM2 is annealed while being pulled in the conveying direction, the rolled material BM3 with a smaller residual stress than the rolled material BM2 prior to annealing is obtained.

The material used to form the base material BM1 may include any one selected from the group consisting of stainless alloy, beryllium copper, nickel-tin-copper, phosphor bronze, Corson alloy, and titanium copper. These metals have a relatively high hardness. In other words, they are less ductile compared to metals with lower hardness (i.e., softer metals) Thus, variations in the degree of rolling are likely to occur in the base material BM1. In addition, the rolling degree is likely to vary between multiple base materials BM1. Thus, the effectiveness of including the above condition 1 in the condition for selecting the metal foil 10 formed by the rolling of the base material BM1 is relatively high.

FIG. 5 schematically shows a step of measuring the thickness of the metal foil 10 formed through the rolling step.

As shown in FIG. 5, multiple rolled materials BM3 obtained through rolling are prepared. Then, a measuring device ME is used to measure the thickness in the first region on which the spring member 20 is formed in each rolled material BM3. Thus, at least the above-described first absolute value is calculated for the first region of each rolled material BM3. Then, from multiple rolled materials BM3, the rolled material BM3 satisfying the above condition 1 is selected as the metal foil 10, and the selected metal foil 10 is used for manufacturing the spring member 20.

The above-described first standard deviation, second standard deviation, second absolute value, and third absolute value may be calculated for the first region of each rolled material BM3. At least one of the above conditions 2 to 4 may be added to the condition for selecting the metal foil 10 from the rolled material BM3. That is, only one of the conditions 2 to 4 may be added to the condition for selecting the metal foil 10 from the rolled material BM3, or two or more selected from conditions 2 to 4 may be added. Additionally, the measuring device ME can be either a contact measuring device or a non-contact measuring device.

The contact measuring device may be, for example, a length gauge. The non-contact measuring device may be, for example, a measuring device including an emitter that emits X-rays and a detector that detects fluorescent X-rays. When this measuring device is used, first, X-rays are emitted to the metal foil 10 using the emitter, and then fluorescent X-rays released from the metal foil 10 are detected using the detector. Since the intensity of the fluorescent X-rays detected by the detector depends on the thickness of the metal foil 10, the thickness of the metal foil 10 can be deduced from the intensity of the fluorescent X-rays.

The first standard deviation, second standard deviation, first variance, second variance, first difference value, and second difference value can be changed by changing at least one of the parameters. The above values can be changed by changing at least one of the rotation speeds of the rollers RL1, RL2, the pressing force between the rollers RL1, RL2, the temperatures of the rollers RL1, RL2, and the number of the rollers RL1, RL2. That is, only one of the rotation speeds of the rollers RL1, RL2, the pressing force between the rollers RL1, RL2, the temperatures of the rollers RL1, RL2, and the number of the rollers RL1, RL2 may be changed. Alternatively, two or more of the rotation speeds of the rollers RL1, RL2, the pressing force between the rollers RL1, RL2, the temperatures of the rollers RL1, RL2, and the number of the rollers RL1, RL2 may be changed.

### Method for Manufacturing Spring Member

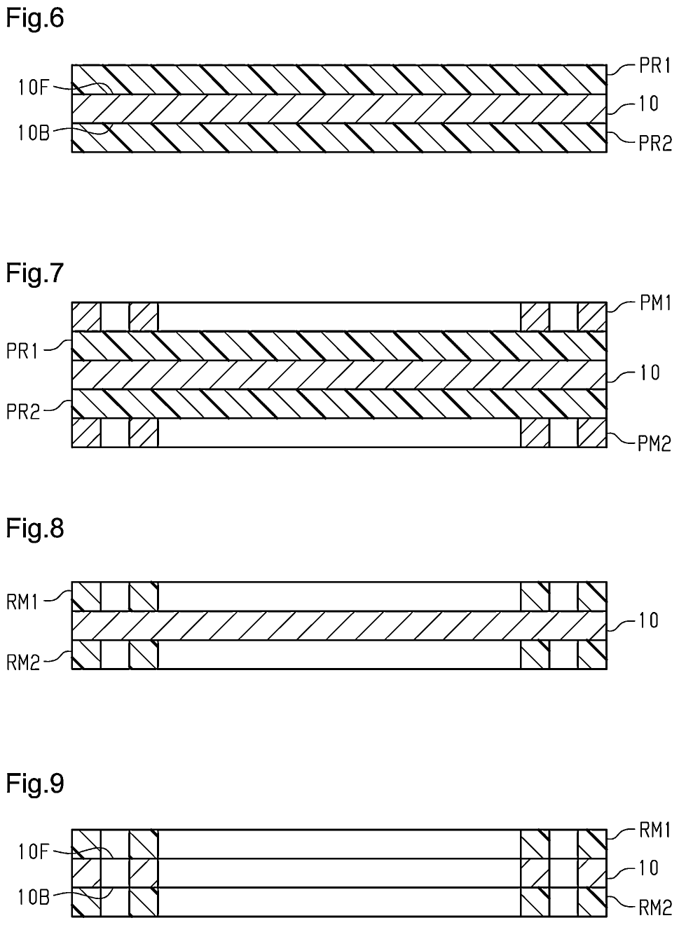

The method for manufacturing the spring member 20 will now be described with reference to FIGS. 6 to 10.

As shown in FIG. 6, to manufacture the spring member 20, first, a first resist layer PR1 is formed on the front surface 10F of the metal foil 10, and a second resist layer PR2 is formed on the back surface 10B. In the example described with reference to FIGS. 6 to 10, each of the resist layers PR1, PR2 is formed from a positive photoresist. Instead, each of the resist layers PR1, PR2 may be formed from a negative photoresist.

Next, as shown in FIG. 7, a first photomask PM1 is disposed on the first resist layer PR1, and a second photomask PM2 is disposed on the second resist layer PM2. Then, the first resist layer PR1 is exposed using the first photomask PM1, and the second resist layer PR2 is exposed using the second photomask PR2.

As shown in FIG. 8, the exposed resist layers PR1, PR2 are developed, thereby forming a first resist mask RM1 from the first resist layer PR1 and a second resist mask RM2 from the second resist layer PR2.

As shown in FIG. 9, the metal foil 10 is wet-etched using the resist masks RM1, RM2. The metal foil 10 is etched from the front surface 10F and the back surface 10B. Thus, a through-hole that extends through the metal foil 10 in the thickness direction is formed in the metal foil 10. This forms the outer frame 21, the inner frame 22, which is separated from the outer frame 21, and the spring portions 23, which connect the inner frame 22 to the outer frame 21.

Since the metal foil 10 satisfies condition 1, the spring member 20 having the desired shape in the thickness direction of the metal foil 10 is likely to be obtained. Additionally, since the metal foil 10 satisfies condition 1, it is possible to obtain the spring member 20 in which the variations in the spring width in the thickness direction of the spring member 20 are limited within a predetermined range without changing the condition of wet-etching based on the variations in the thickness of the metal foil 10. This eliminates the need to modify the condition of wet-etching based on the variations in thickness in the process of manufacturing the spring member 20. Consequently, errors that result from the combination of thickness variations and the wet-etching condition are eliminated.

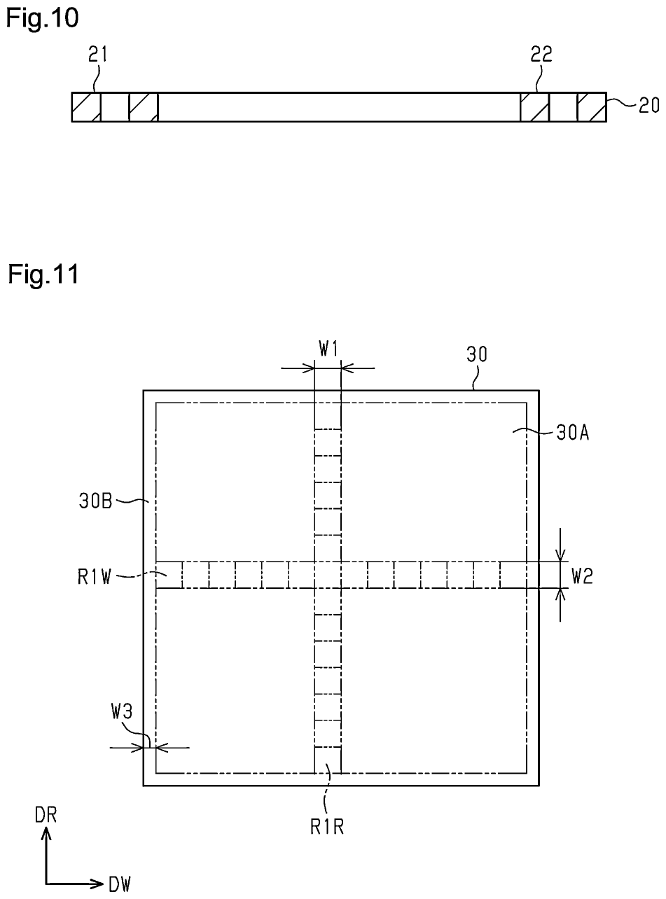

As shown in FIG. 10, the resist masks RM1, RM2 are removed from the etched metal foil 10 and then the spring member 20 is cut out from the etched metal foil 10, thereby obtaining the spring member 20.

### EXAMPLES

Examples and Comparative Examples will be described with reference to FIGS. 11 to 16.

### Example 1

First, a base material made of titanium copper was subjected to a rolling step to form a rolled material. Next, the rolled material was subjected to an annealing step. Thus, a metal foil of Example 1 having a design value of thickness of 120 μm was obtained.

### Examples 2 to 8 and Comparative Examples 1 to 3

Metal foils of Examples 2 to 8 and Comparative Examples 1 to 3 were obtained in the same manner as in Example 1, except that at least one of the rotation speeds of the rollers, the pressing force between the rollers, the temperatures of the rollers, and the number of rollers was changed during rolling of the base material in Example 1.

### Evaluation Method

### Measurement of Thickness

The method for measuring the thickness of the metal foil 10 will now be described with reference to FIG. 11.

As shown in FIG. 11, a measurement metal foil 30 having a square shape with one side being 300 mm was cut out from the metal foils of Examples and Comparative Examples. The measurement metal foil 30 was cut out from each metal foil such that the direction in which the first side of each measurement metal foil 30 extended was parallel to the rolling direction DR of the metal foil, and the direction in which the second side of each measurement metal foil 30 extended was perpendicular to the width direction DW of the metal foil. In each measurement metal foil 30, a measurement region 30A and a surrounding region 30B were set. The measurement region 30A included the center of the measurement metal foil 30 and had a square shape. The surrounding region 30B had a rectangular frame shape surrounding the measurement region 30A. Width W3 of the surrounding region 30B was set to 10 mm.

Further, the first measurement region R1R, having a band shape that extends in the rolling direction DR, and the second measurement region R1W, having a band shape that extends in the width direction DW, were set within the measurement region 30A. Width W1 of the first measurement region R1R in the width direction DW was set to 20 mm. Width W2 of the second measurement region R1W in the rolling direction DR was set to 20 mm.

The thickness of the metal foil was measured in all of the fourteen equally divided sections of the first measurement region R1R in the rolling direction DR. Further, the thickness of the measurement metal foil 30 was measured in all of the fourteen equally divided sections of the second measurement region R1W in the width direction DW.

In each section, the thickness was measured at the point where the diagonal lines connecting the two opposing corners intersected. That is, the thickness was measured at each point on the same straight line. The thickness of each measurement metal foil was measured at the fourteen points in the rolling direction DR and at the fourteen points in the width direction DW. In the region where the first measurement region R1R and the second measurement region R1W intersected each other, the measurement point in the rolling direction DR was the same as the measurement point in the width direction DW. Thus, the thickness of each measurement metal foil was measured at twenty-seven points in total. Then, the measured value was rounded off to the second decimal place, thereby obtaining a measurement of the thickness in each region.

From these measurements, the first standard deviation, the second standard deviation, the first variance, and the second variance were calculated. In addition, the third difference value, which was the difference value obtained by subtracting the second standard deviation from the first standard deviation, and the first absolute value, which was the absolute value of the third difference value, were calculated. Further, the fourth difference value, which was the difference value obtained by subtracting the second variance from the first variance, and the second absolute value, which was the absolute value of the fourth difference value, were calculated. Furthermore, the third absolute value, which was the absolute value of the difference value obtained by subtracting the second difference value from the first difference value, and the fourth absolute value, which was the absolute value of the difference value obtained by subtracting the maximum value of the thickness in the width direction DW from the maximum value of the thickness in the rolling direction DR, were calculated.

The thickness of the measurement metal foil 30 was measured using a contact thickness gauge (manufactured by Nikon Corporation, MH-15M). To measure the thickness, first, a probe was brought into contact with the base plate, and then the power of the thickness gauge counter attached to the measuring device was turned on, thereby performing zero calibration. Afterward, the measurement metal foil was placed between the probe and the base plate, and then the probe was lowered to measure the thickness at each point on the measurement metal foil.

### Evaluation of Etching Pattern

A resist mask with multiple openings that conform to the shape of the spring member 20 was formed on the front and back surfaces of each measurement metal foil 30. The measurement metal foil 30 was wet-etched from the front and back surfaces using the two resist masks. In the measurement region 30A, unit areas corresponding to a single spring member 20 and having a square shape of 20 mm on each side were arranged in a grid pattern to cover the region in the rolling direction DR and the width direction DW. Thus, unit patterns corresponding to the shape of a single spring member 20 were arranged in a grid pattern on each resist mask, covering the rolling direction DR and the width direction DW.

The unit patterns included the section of the spring member 20 forming the spring portion 23, which had a zigzag shape. In this section, the opening width of the resist pattern corresponding to the gap between line segments of the spring portion 23 that were parallel to and adjacent to each other was set to 100 μm, and the pitch between the adjacent line segments was set to 200 μm. The pitch of the adjacent line segments referred to the distance between the center lines set for the line segments, which were parallel to and adjacent to each other, in the design of etching pattern.

On each resist mask, multiple unit patterns were formed so that, in a plan view facing the front surface of the measurement metal foil 30, the entire unit pattern of the resist mask on the front surface of the measurement metal foil 30 was overlapped with the entire unit pattern on the resist mask on the back surface of the measurement metal foil 30.

Using such a resist mask, etching patterns corresponding to the shape of the spring member 20 were formed in the measurement metal foil 30. In the etching patterns, the design value of the spring width of the spring portion 23 in a plan view was set to 30 μm.

The spring portion 23 of the spring member 20 in each etched measurement metal foil 30 was embedded using synthetic resin. Then, the embedded spring portion 23 was cut using a microtome to expose the cross-section of the spring portion 23 in a plane orthogonal to the direction in which the line segment included in the spring portion extended.

In the cross-section of the spring portion 23, the spring width was measured at the following position. In the spring portion 23, the spring width on the front surface of the measurement metal foil 30 and the spring width on the back surface of the measurement metal foil 30 were measured. Further, of the plane that divided the spring portion 23 into four equal parts in the thickness direction, the spring widths on three planes located between the front and back surfaces of the measurement metal foil 30 were measured. That is, when the depth of the measurement metal foil 30 on the front surface was set to 0 μm, the spring width at a depth of 0 μm, the spring width at a depth of about 30 μm, the spring width at a depth of about 60 μm, the spring width at a depth of about 90 μm, and the spring width at a depth of about 120 μm were measured in the etching patterns. To measure the spring width of the spring portion 23, a digital microscope (VHX-7000, manufactured by Keyence Corporation) was used, and the magnification of the objective lens in the digital microscope was set to 200 times.

A first specified value, the standard deviation of the spring width, a second specified value, the percentage of 36 relative to the average value of the spring width, and the variance of the spring width were calculated for the etching pattern obtained from the measurement metal foil 30 of each of Examples and Comparative Examples.

For each unit pattern included in the measurement metal foil 30, the spring widths of all the springs included in the spring portion 23 were measured at the above-described five positions in the thickness direction. Then, the maximum value and the minimum value were specified for each spring, the difference value obtained by subtracting the maximum value from the minimum value was calculated, and the average value of the spring widths was calculated. Next, the average value of the maximum values specified for all the springs was calculated, and this average value was set as the maximum value of the spring width in the measurement metal foil 30. Further, the average value of the minimum values specified for all the springs was calculated, and this average value was set as the minimum value of the spring width in the measurement metal foil 30. Furthermore, the average value of the difference values calculated for all the springs was calculated, and this average value was set as the difference value of the measurement metal foil 30. In addition, the average value of the average values calculated for all the springs was calculated, and this average value was set as the average value of the measurement metal foil 30.

Further, the first specified value, the standard deviation of the spring width, the second specified value, and the percentage of 30 relative to the average value of the spring width were calculated for the etching pattern obtained from the measurement metal foil 30 of each of Examples and Comparative Examples. To calculate the percentage of 30 relative to the average value of the spring width, the average value set for each measurement metal foil 30 was used. The first specified value was a percentage of the difference value of the spring width relative to the design value of the spring width. To calculate the first specified value, the difference value set for each measurement metal foil 30 was used. The second specified value was a percentage of the standard deviation of the spring width relative to the design value of the spring width.

To calculate the standard deviation of the spring width, first, the standard deviation of the spring width was calculated from the thicknesses at five points measured for each spring. Next, the average value of the standard deviations calculated for all the springs was calculated, and this average value was set as the standard deviation of the spring width of the measurement metal foil 30. To calculate the second specified value, the standard deviation set for each measurement metal foil 30 was used.

To calculate the variance of the spring width, first, the variance of the spring width was calculated from the thicknesses at five points measured for each spring. Next, the average value of the variances calculated for all the springs was calculated, and this average value was set as the variance of the spring width in the measurement metal foil 30.

### Evaluation Results

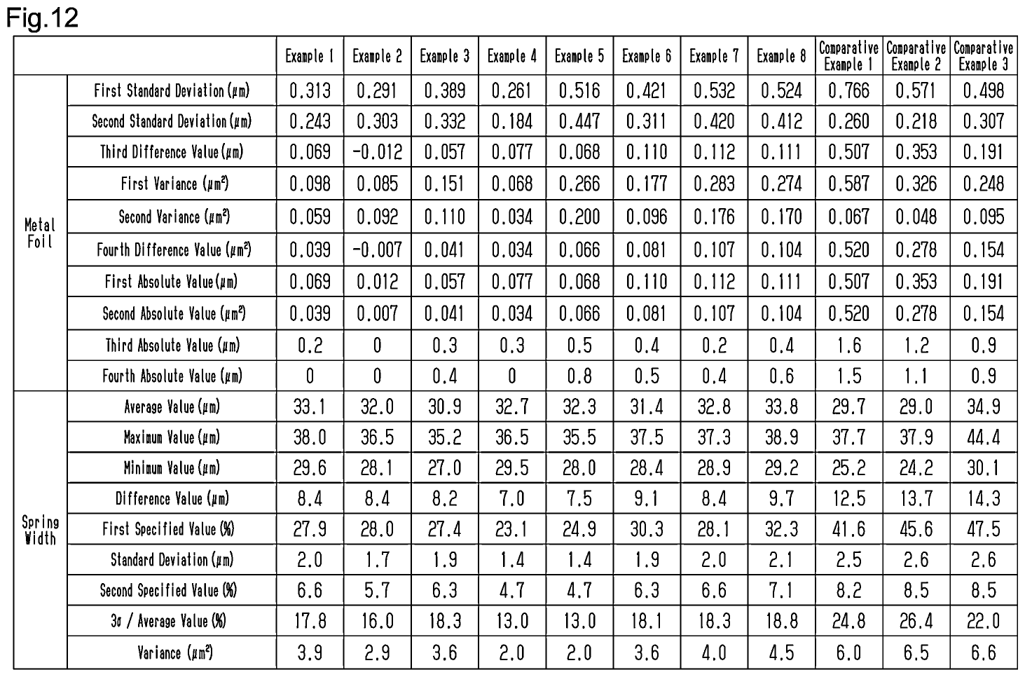

The evaluation results of the thickness of the measurement metal foil 30 and the spring width of the etching pattern will now be described with reference to FIGS. 12 to 14.

FIG. 12 shows the measurement results of the thickness of each measurement metal foil 30, and the measurement results of the spring width of the etching pattern formed by wet-etching each measurement metal foil 30. In FIG. 12, the first absolute value is the absolute value of the difference value obtained by subtracting the second standard deviation from the first standard deviation, the fourth absolute value is the absolute value of the difference value obtained by subtracting the maximum value of the thickness in the width direction DW from the maximum value of the thickness in the rolling direction DR.

As shown in FIG. 12, it was confirmed that the first standard deviation was 0.313 μm in Example 1, 0.291 μm in Example 2, 0.389 μm in Example 3, and 0.261 μm in Example 4. Further, it was confirmed that the first standard deviation was 0.516 μm in Example 5, 0.421 μm in Example 6, 0.532 μm in Example 7, and 0.524 μm in Example 8. Furthermore, it was confirmed that the first standard deviation was 0.766 μm in Comparative Example 1, 0.571 μm in Comparative Example 2, and 0.498 μm in Comparative Example 3.

It was confirmed that the second standard deviation was 0.243 μm in Example 1, 0.303 μm in Example 2, 0.332 μm in Example 3, and 0.184 μm in Example 4. Further, it was confirmed that the second standard deviation was 0.447 μm in Example 5, 0.311 μm in Example 6, 0.420 μm in Example 7, and 0.412 μm in Example 8. Furthermore, it was confirmed that the second standard deviation was 0.260 μm in Comparative Example 1, 0.218 μm in Comparative Example 2, and 0.307 μm in Comparative Example 3.

Thus, it was confirmed that the third difference value was 0.069 μm in Example 1, −0.012 μm in Example 2, 0.057 μm in Example 3, and 0.077 μm in Example 4. Further, it was confirmed that the third difference value was 0.068 μm in Example 5, 0.110 μm in Example 6, 0.112 μm in Example 7, and 0.111 μm in Example 8. Furthermore, it was confirmed that the third difference value was 0.507 μm in Comparative Example 1, 0.353 μm in Comparative Example 2, and 0.191 μm in Comparative Example 3.

It was confirmed that the first absolute value was 0.069 μm in Example 1, 0.012 μm in Example 2, 0.057 μm in Example 3, and 0.077 μm in Example 4. Further, it was confirmed that the first absolute value was 0.068 μm in Example 5, 0.110 μm in Example 6, 0.112 μm in Example 7, and 0.111 μm in Example 8. Furthermore, it was confirmed that the first absolute value was 0.507 μm in Comparative Example 1, 0.353 μm in Comparative Example 2, and 0.191 μm in Comparative Example 3.

Thus, it was confirmed that the first absolute value was less than or equal to 0.15 μm in the measurement metal foil 30 of Examples 1 to 8 whereas the first absolute value was larger than 0.15 μm in the measurement metal foils 30 of Comparative Examples 1 to 3. Specifically, it was confirmed that the first absolute value was between 0.012 μm and 0.112 μm, inclusive, in the measurement metal foils 30 of Examples 1 to 8 whereas the first absolute value was between 0.191 μm and 0.507 μm, inclusive, in the measurement metal foils 30 of Comparative Examples 1 to 3. In addition, it was confirmed that the first standard deviation was larger than the second standard deviation in the measurement metal foils 30 of Examples 1, 3, 8 and the measurement metal foils 30 of Comparative Examples 1 to 3 whereas the first standard deviation was smaller than the second standard deviation in Example 2.

It was confirmed that the first variance was 0.098 μm² in Example 1, 0.085 μm² in Example 2, 0.151 μm² in Example 3, and 0.068 μm² in Example 4. It was confirmed that the first variance was 0.266 μm² in Example 5, 0.177 μm² in Example 6, 0.283 μm² in Example 7, and 0.274 μm² in Example 8. It was confirmed that the first variance was 0.587 μm² in Comparative Example 1, 0.326 μm² in Comparative Example 2, and 0.248 μm² in Comparative Example 3.

It was confirmed that the second variance was 0.059 μm² in Example 1, 0.092 μm² in Example 2, 0.110 μm² in Example 3, and 0.034 μm² in Example 4. It was confirmed that the second variance was 0.200 μm² in Example 5, 0.096 μm² in Example 6, 0.176 μm² in Example 7, and 0.170 μm² in Example 8. It was confirmed that the second variance was 0.067 μm² in Comparative Example 1, 0.048 μm² in Comparative Example 2, and 0.095 μm² in Comparative Example 3.

Thus, it was confirmed that the fourth difference value was 0.039 μm² in Example 1, −0.007 μm² in Example 2, 0.041 μm² in Example 3, and 0.034 μm² in Example 4. It was confirmed that the fourth difference value was 0.066 μm² in Example 5, 0.081 μm² in Example 6, 0.107 μm² in Example 7, and 0.104 μm² in Example 8. In addition, it was confirmed that the fourth difference value was 0.520 μm² in Comparative Example 1, 0.278 μm² in Comparative Example 2, and 0.154 μm² in Comparative Example 3.

It was confirmed that the second absolute value was 0.039 μm² in Example 1, 0.007 μm² in Example 2, 0.041 μm² in Example 3, and 0.034 μm² in Example 4. It was confirmed that the second absolute values was 0.066 μm² in Example 5, 0.081 μm² in Example 6, 0.107 μm² in Example 7, and 0.104 μm² in Example 8. Further, it was confirmed that the second absolute value was 0.520 μm² in Comparative Example 1, 0.278 μm² in Comparative Example 2, and 0.154 μm² in Comparative Example 3. Thus, it was confirmed that the second absolute values of the measurement metal foils 30 of Examples 1 to 8 were less than or equal to 0.15 μm² whereas the second absolute values of the measurement metal foils 30 of Comparative Examples 1 to 3 were larger than 0.15 μm². Specifically, it was confirmed that the second absolute values of the measurement metal foils 30 of Examples 1 to 8 were between 0.007 μm² and 0.107 μm², inclusive, while the second absolute values of the measurement metal foils 30 of Comparative Examples 1 to 3 were between 0.154 μm² and 0.520 μm², inclusive.

It was confirmed that the third absolute value was 0.2 μm in Example 1, 0 μm in Example 2, 0.3 μm in Example 3, and 0.3 μm in Example 4. Further, it was confirmed that the third absolute value was 0.5 μm in Example 5, 0.4 μm in Example 6, 0.2 μm in Example 7, and 0.4 μm in Example 8. Furthermore, it was confirmed that the third absolute value was 1.6 μm in Comparative Example 1, 1.2 μm in Comparative Example 2, and 0.9 μm in Comparative Example 3.

Additionally, it was confirmed that the fourth absolute value was 0 μm in Example 1, 0 μm in Example 2, 0.4 μm in Example 3, and 0 μm in Example 4. It was confirmed that the fourth absolute value was 0.8 μm in Example 5, 0.5 μm in Example 6, 0.4 μm in Example 7, and 0.6 μm in Example 8. It was confirmed that the fourth absolute value was 1.5 μm in Comparative Example 1, 1.1 μm in Comparative Example 2, and 0.9 μm in Comparative Example 3.

It was confirmed that the difference value in spring width was 8.4 μm in Example 1, 8.4 μm in Example 2, 8.2 μm in Example 3, and 7.0 μm in Example 4. Further, it was confirmed that the difference value in spring width was 7.5 μm in Example 5, 9.1 μm in Example 6, 8.4 μm in Example 7, and 9.7 μm in Example 8. Furthermore, it was confirmed that the difference value in spring width was 12.5 μm in Comparative Example 1, 13.7 μm in Comparative Example 2, and 14.3 μm in Comparative Example 3.

In addition, it was confirmed that the first specified value was 27.9% in Example 1, 28.0% in Example 2, 27.4% in Example 3, and 23.1% in Example 4. Further, it was confirmed that the first specified value was 24.9% in Example 5, 30.3% in Example 6, 28.1% in Example 7, and 32.3% in Example 8. Furthermore, it was confirmed that the first specified value was 41.6% in Comparative Example 1, 45.6% in Comparative Example 2, and 47.5% in Comparative Example 3.

It was confirmed that the standard deviation of the spring width was 2.0 μm in Example 1, 1.7 μm in Example 2, 1.9 μm in Example 3, and 1.4 μm in Example 4. It was confirmed that the standard deviation of the spring width was 1.4 μm in Example 5, 1.9 μm in Example 6, 2.0 μm in Example 7, and 2.1 μm in Example 8. It was confirmed that the standard deviation of the spring width was 2.5 μm in Comparative Example 1, 2.6 μm in Comparative Example 2, and 2.6 μm in Comparative Example 3.

It was confirmed that the second specified value was 6.6% in Example 1, 5.7% in Example 2, 6.3% in Example 3, and 4.7% in Example 4. It was confirmed that the second specified value was 4.7% in Example 5, 6.3% in Example 6, 6.6% in Example 7, and 7.1% in Example 8. It was confirmed that the second specified value was 8.2% in Comparative Example 1, 8.5% in Comparative Example 2, and 8.5% in Comparative Example 3.

It was confirmed that the percentage of 36 relative to the average value of the spring width was 17.8% in Example 1, 16.0% in Example 2, 18.3% in Example 3, and 13.0% in Example 4. It was confirmed that the percentage of 30 relative to the average value of the spring width was 13.0% in Example 5, 18.1% in Example 6, 18.3% in Example 7, and 18.8% in Example 8. It was confirmed that the percentage of 30 relative to the average value of the spring width was 24.8% in Comparative Example 1, 26.4% in Comparative Example 2, and 22.0% in Comparative Example 3.

It was confirmed that the variance of the spring widths was 3.9 μm² in Example 1, 2.9 μm² in Example 2, 3.6 μm² in Example 3, and 2.0 μm² in Example 4. It was confirmed that the variance of the spring widths was 2.0 μm² in Example 5, 3.6 μm² in Example 6, 4.0 μm² in Example 7, and 4.5 μm² in Example 8. It was confirmed that the variance of the spring widths was 6.0 μm² in Comparative Example 1, 6.5 μm² in Comparative Example 2, and 6.6 μm² in Comparative Example 3.

Thus, it was confirmed that all of the first specified value, the standard deviation, the second specified value, the percentage of 30 relative to the average value, and the variance of the metal foils for the spring members of Examples 1 to 8 were smaller than those of the metal foils for the spring members of Comparative Examples 1 to 3. Accordingly, the metal foils for the spring members of Examples 1 to 8 have smaller variations in the spring width in the thickness direction than the metal foils for the spring members of Comparative Examples 1 to 3.

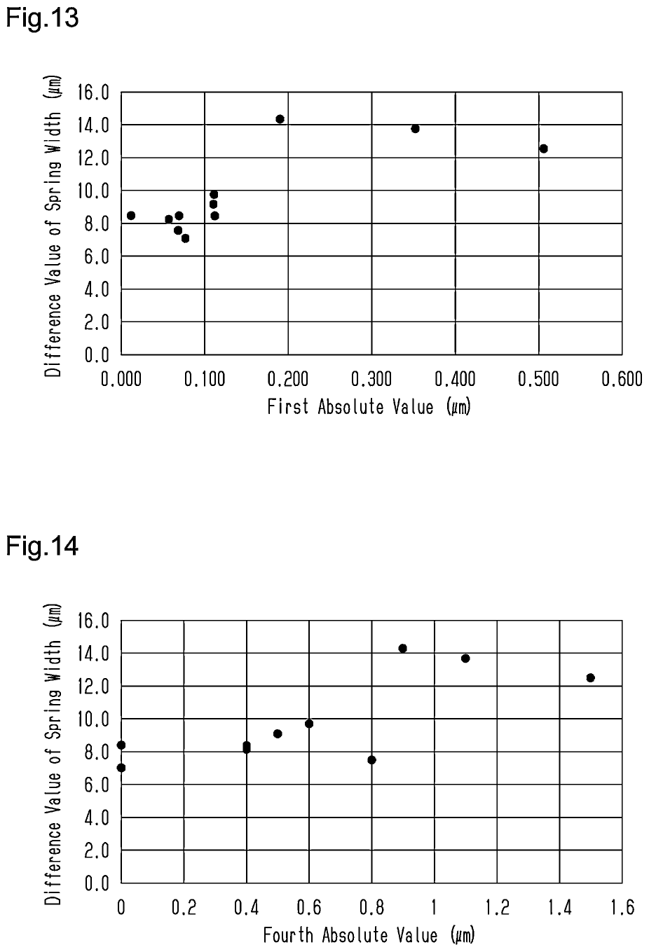

FIG. 13 is a graph showing the relationship between the first absolute value and the difference value of the spring width.

As shown in FIG. 13, it was confirmed that when the first absolute value was less than or equal to 0.15 μm, the difference value in the spring width of the etching pattern was in the range of between 6.0 μm and 10.0 μm, inclusive. By contrast, it was confirmed that when the first absolute value was larger than 0.15 μm, the difference value in the spring width of the etching pattern was greater than 11 μm. Thus, it was confirmed that the variations in the spring width of the etching pattern significantly differ around the boundary of 0.15 μm in the first absolute value.

FIG. 14 is a graph showing the relationship between the fourth absolute value and the difference value of the spring width.

As shown in FIG. 14, it was confirmed that when the fourth absolute value was less than or equal to 0.8 μm, the difference value in the spring width of the etching pattern was in the range of between 6.0 μm and 10.0 μm, inclusive. By contrast, it was confirmed that when the fourth absolute value was larger than 0.8 μm, the difference value in the spring width of the etching pattern was greater than 11 μm. Thus, it was confirmed that the variations in the spring width of the etching pattern significantly differ around the boundary of 0.8 μm in the fourth absolute value.

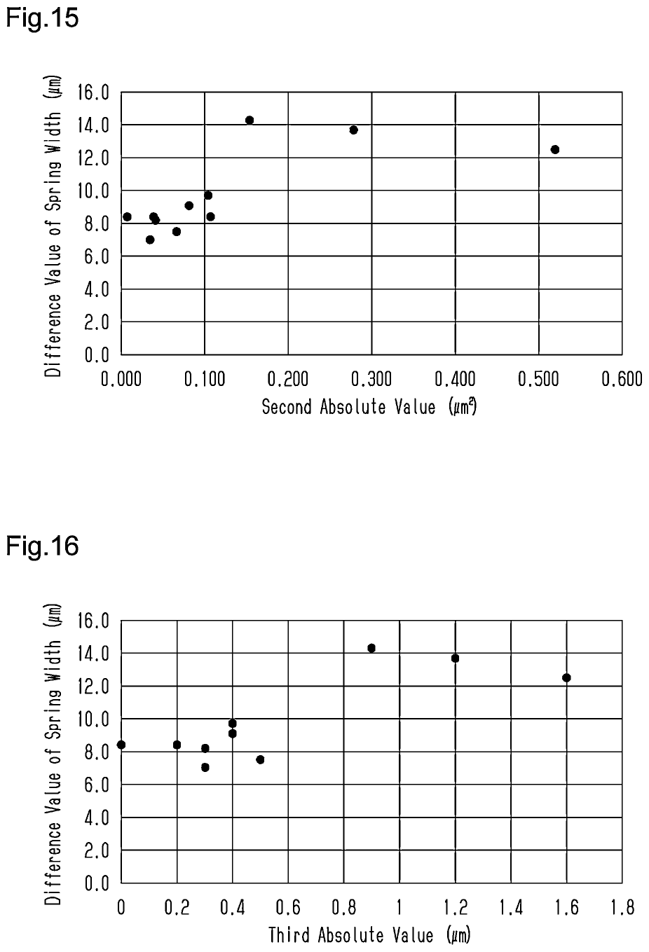

FIG. 15 is a graph showing the relationship between the second absolute value and the difference value of the spring width.

As shown in FIG. 15, it was confirmed that when the second absolute value was less than or equal to 0.15 μm², the difference value in the spring width of the etching pattern was in the range of between 6.0 μm and 10.0 μm, inclusive. By contrast, it was confirmed that when the second absolute value was larger than 0.15 μm², the difference value in the spring width of the etching pattern was greater than 11 μm. Thus, it was confirmed that the variations in the spring width of the etching pattern significantly differ around the boundary of 0.15 μm² in the second absolute value.

FIG. 16 is a graph showing the relationship between the third absolute value and the difference value of the spring width.

As shown in FIG. 16, it was confirmed that when the third absolute value was less than or equal to 0.8 μm, the difference value in the spring width of the etching pattern was in the range of between 6.0 μm and 10.0 μm, inclusive. By contrast, it was confirmed that when the third absolute value was larger than 0.8 μm, the difference value in the spring width of the etching pattern was greater than 11 μm. Thus, it was confirmed that the variations in the spring width of the etching pattern significantly differ around the boundary of 0.8 μm in the third absolute value.

As described above, the metal foil for the spring member, the method for manufacturing the metal foil for the spring member, and the spring member for the electronic device according to the embodiment provide the following advantages.

(1) The metal foil 10 satisfies condition 1. This limits variations in the thickness of the metal foil 10. Thus, variations are limited in the spring width in the thickness direction of the spring member 20 that has been formed by wet-etching the metal foil 10.

(2) The metal foil 10 satisfies at least one of conditions 2 to 4. This limits variations in the thickness of the metal foil 10. Thus, variations are limited in the width in the thickness direction of the spring member 20.

(3) The metal foil 10 can have a relatively high hardness. This improves the durability of the spring member 20 that has been formed from the metal foil 10.

1. A metal foil for a spring member used to manufacture a spring member, the metal foil comprising:
a first region on which the spring member is formed, the first region having a square shape with one side being 300 mm, wherein, in the first region,
an absolute value of a difference value obtained by subtracting variance of a thickness in a width direction orthogonal to a rolling direction from variance of a thickness in the rolling direction is less than or equal to 0.15 μm², and
a maximum value of the thickness in the rolling direction is a first maximum value, a maximum value of the thickness in the width direction is a second maximum value, and an absolute value obtained by subtracting the second maximum value from the first maximum value is less than or equal to 0.8 μm.

2. The metal foil for the spring member according to claim 1, wherein
in the first region, a difference value obtained by subtracting a standard deviation of the thickness in the width direction from a standard deviation of the thickness in the rolling direction is less than or equal to 0.15 μm.

3. The metal foil for the spring member according to claim 1, wherein
in the first region, a difference value obtained by subtracting the variance of the thickness in the width direction from the variance of the thickness in the rolling direction is less than or equal to 0.15 μm².

4. The metal foil for the spring member according to claim 1, wherein, in the first region,
a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.

5. The metal foil for the spring member according to claim 1, wherein, in the first region,
a difference value obtained by subtracting a standard deviation of the thickness in the width direction from a standard deviation of the thickness in the rolling direction is less than or equal to 0.15 μm, and
a difference value obtained by subtracting the variance of the thickness in the width direction from the variance of the thickness in the rolling direction is less than or equal to 0.15 μm².

6. The metal foil for the spring member according to claim 1, wherein, in the first region,
a difference value obtained by subtracting a standard deviation of the thickness in the width direction from a standard deviation of the thickness in the rolling direction is less than or equal to 0.15 μm,
a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.

7. The metal foil for the spring member according to claim 1, wherein, in the first region,
a difference value obtained by subtracting the variance of the thickness in the width direction from the variance of the thickness in the rolling direction is less than or equal to 0.15 μm²,
a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.

8. The metal foil for the spring member according to claim 1, wherein, in the first region,
a difference value obtained by subtracting a standard deviation of the thickness in the width direction from a standard deviation of the thickness in the rolling direction is less than or equal to 0.15 μm,
a difference value obtained by subtracting the variance of the thickness in the width direction from the variance of the thickness in the rolling direction is less than or equal to 0.15 μm²,
a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.

9. A method for manufacturing a metal foil for a spring member used to manufacture the spring member, the method comprising:
rolling a base material; and
preparing rolled materials obtained by rolling the base material and then selecting the metal foil for the spring member from the rolled materials, wherein
each of the rolled materials includes a first region on which the spring member is formed, the first region having a square shape with one side being 300 mm,
in the first region, a maximum value of a thickness in a rolling direction is a first maximum value, and a maximum value of a thickness in a width direction is a second maximum value, and
the selecting the metal foil for the spring member selects, from the rolled materials, as the metal foil for the spring member, the rolled material in which an absolute value of a difference value obtained by subtracting variance of the thickness in the width direction from variance of the thickness in the rolling direction is less than or equal to 0.15 μm² and an absolute value obtained by subtracting the second maximum value from the first maximum value is less than or equal to 0.8 μm.

10. The method for manufacturing the metal foil for the spring member according to claim 9, wherein
the selecting the metal foil for the spring member further includes, as a condition for selecting the metal foil for the spring member, the condition that an absolute value of a difference value obtained by subtracting a standard deviation of the thickness in the width direction from a standard deviation of the thickness in the rolling direction is less than or equal to 0.15 μm in the first region.

11. The method for manufacturing the metal foil for the spring member according to claim 9, wherein
the selecting the metal foil for the spring member includes, as a condition for selecting the metal foil for the spring member, the condition that a difference value obtained by subtracting the variance of the thickness in the width direction from the variance of the thickness in the rolling direction is less than or equal to 0.15 μm² in the first region.

12. The method for manufacturing the metal foil for the spring member according to claim 9, wherein
in the first region, a difference value obtained by subtracting a minimum value from the maximum value of the thickness in the rolling direction is a first difference value, and a difference value obtained by subtracting a minimum value from the maximum value of the thickness in the width direction is a second difference value, and
the selecting the metal foil for the spring member includes, as a condition for selecting the metal foil for the spring member, the condition that an absolute value of a difference value obtained by subtracting the second difference value from the first difference value is less than or equal to 0.8 μm.

13. The method for manufacturing the metal foil for the spring member according to claim 9, wherein
as a condition for selecting the metal foil for the spring member, the selecting the metal foil for the spring member includes:
the condition that an absolute value of a difference value obtained by subtracting a standard deviation of the thickness in the width direction from a standard deviation of the thickness in the rolling direction is less than or equal to 0.15 μm in the first region; and
the condition that a difference value obtained by subtracting the variance of the thickness in the width direction from the variance of the thickness in the rolling direction is less than or equal to 0.15 μm² in the first region.

14. The method for manufacturing the metal foil for the spring member according to claim 9, wherein
in the first region, a difference value obtained by subtracting a minimum value from the maximum value of the thickness in the rolling direction is a first difference value, and a difference value obtained by subtracting a minimum value from the maximum value of the thickness in the width direction is a second difference value, and
as a condition for selecting the metal foil for the spring member, the selecting the metal foil for the spring member includes:
the condition that an absolute value of a difference value obtained by subtracting a standard deviation of the thickness in the width direction from a standard deviation of the thickness in the rolling direction is less than or equal to 0.15 μm in the first region; and
the condition that an absolute value of a difference value obtained by subtracting the second difference value from the first difference value is less than or equal to 0.8 μm.

15. The method for manufacturing the metal foil for the spring member according to claim 9, wherein
in the first region, a difference value obtained by subtracting a minimum value from the maximum value of the thickness in the rolling direction is a first difference value, and a difference value obtained by subtracting a minimum value from the maximum value of the thickness in the width direction is a second difference value, and
as a condition for selecting the metal foil for the spring member, the selecting the metal foil for the spring member includes:
the condition that a difference value obtained by subtracting the variance of the thickness in the width direction from the variance of the thickness in the rolling direction is less than or equal to 0.15 μm² in the first region; and
the condition that an absolute value of a difference value obtained by subtracting the second difference value from the first difference value is less than or equal to 0.8 μm.

16. The method for manufacturing the metal foil for the spring member according to claim 9, wherein
in the first region, a difference value obtained by subtracting a minimum value from the maximum value of the thickness in the rolling direction is a first difference value, and a difference value obtained by subtracting a minimum value from the maximum value of the thickness in the width direction is a second difference value, and
as a condition for selecting the metal foil for the spring member, the selecting the metal foil for the spring member includes:
the condition that an absolute value of a difference value obtained by subtracting a standard deviation of the thickness in the width direction from a standard deviation of the thickness in the rolling direction is less than or equal to 0.15 μm in the first region
the condition that a difference value obtained by subtracting the variance of the thickness in the width direction from the variance of the thickness in the rolling direction is less than or equal to 0.15 μm² in the first region; and
the condition that an absolute value of a difference value obtained by subtracting the second difference value from the first difference value is less than or equal to 0.8 μm.

17. A spring member for an electronic device formed from a metal foil for a spring member, wherein
an absolute value of a difference value obtained by subtracting variance of a thickness of the metal foil for the spring member in a width direction orthogonal to a rolling direction from variance of the thickness of the metal foil for the spring member in the rolling direction is less than or equal to 0.15 μm², and
in the metal foil for the spring member, a maximum value of the thickness in the rolling direction is a first maximum value, a maximum value of the thickness in the width direction is a second maximum value, and an absolute value obtained by subtracting the second maximum value from the first maximum value is less than or equal to 0.8 μm.

18. The spring member for the electronic device according to claim 17, wherein
in the metal foil for the spring member, a difference value obtained by subtracting a standard deviation of the thickness in the width direction from a standard deviation of the thickness in the rolling direction is less than or equal to 0.15 μm.

19. The spring member for the electronic device according to claim 17, wherein
in the metal foil for the spring member, a difference value obtained by subtracting the variance of the thickness in the width direction from the variance of the thickness in the rolling direction is less than or equal to 0.15 μm².

20. The spring member for the electronic device according to claim 17, wherein, in the metal foil for the spring member,
a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.

21. The spring member for the electronic device according to claim 17, wherein, in the metal foil for the spring member,
a difference value obtained by subtracting a standard deviation of the thickness in the width direction from a standard deviation of the thickness in the rolling direction is less than or equal to 0.15 μm, and
a difference value obtained by subtracting the variance of the thickness in the width direction from the variance of the thickness in the rolling direction is less than or equal to 0.15 μm².

22. The spring member for the electronic device according to claim 17, wherein,
in the metal foil for the spring member, a difference value obtained by subtracting a standard deviation of the thickness in the width direction from a standard deviation of the thickness in the rolling direction is less than or equal to 0.15 μm,
in the metal foil for the spring member, a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.

23. The spring member for the electronic device according to claim 17, wherein,
in the metal foil for the spring member, a difference value obtained by subtracting the variance of the thickness in the width direction from the variance of the thickness in the rolling direction is less than or equal to 0.15 μm²,
in the metal foil for the spring member, a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.

24. The spring member for the electronic device according to claim 17, wherein, in the metal foil for the spring member,
a difference value obtained by subtracting a standard deviation of the thickness in the width direction from a standard deviation of the thickness in the rolling direction is less than or equal to 0.15 μm,
a difference value obtained by subtracting the variance of the thickness in the width direction from the variance of the thickness in the rolling direction is less than or equal to 0.15 μm²,
a difference value obtained by subtracting a minimum value from the maximum value of the thickness in the rolling direction is a first difference value, and a difference value obtained by subtracting a minimum value from the maximum value of the thickness in the width direction is a second difference value, and
an absolute value of a difference value obtained by subtracting the second difference value from the first difference value is less than or equal to 0.8 μm.
